(19) United States
(12) Patent Application Publication
(10) Pub. No.: US 2025/0018466 A1
(43) Pub. Date: Jan. 16, 2025

(54) PARTICULATE MATERIAL

(71) Applicant: HERAEUS PRECIOUS METALS GMBH & CO. KG., Hanau (DE)

(72) Inventors: Ana-Lucia MEZA-CHINCHA, Hanau (DE); Michael GOCK, Hanau (DE); Milena KOVJENIC, Hanau (DE)

(21) Appl. No.: 18/713,034

(22) PCT Filed: Jul. 20, 2022
(86) PCT No.: PCT/EP2022/070324

§ 371 Date: May 23, 2024

(30) Foreign Application Priority Data
Nov. 26, 2021 (EP) 21210722.1

(51) Int. Cl. B22F 1/12; A01N 59/16

(52) U.S. Cl. CPC B22F 1/12; A01N 59/16; B22F 2301/255

(57) ABSTRACT

A particulate material Z composed of 15 to 50 wt % of particles X consisting of water-insoluble support material T provided with elemental silver and elemental ruthenium and 50 to 85 wt % of solid Y at least partially disposed on the particles X, wherein the solid Y is selected from the group consisting of aluminum oxide, aluminum hydroxide, aluminum oxyhydroxide, magnesium oxide, magnesium hydroxide, magnesium oxyhydroxide, calcium oxide, calcium hydroxide, calcium oxyhydroxide, silicon dioxide, silica, zinc oxide, zinc hydroxide, zinc oxyhydroxide, zirconium dioxide, zirconium(IV) oxyhydrates, titanium dioxide, titanium(IV) oxyhydrates, and combinations thereof.

The invention relates to a particulate material (powder) composed of water-insoluble support material provided with elemental silver and elemental ruthenium, having solid that is at least partially disposed on the particles. The solid is selected from the group consisting of aluminum oxide, aluminum hydroxide, aluminum oxyhydroxide, magnesium oxide, magnesium hydroxide, magnesium oxyhydroxide, calcium oxide, calcium hydroxide, calcium oxyhydroxide, silicon dioxide, silica, zinc oxide, zinc hydroxide, zinc oxyhydroxide, zirconium dioxide, zirconium(IV) oxyhydrates, titanium dioxide, titanium(IV) oxyhydrates, and combinations thereof. The invention also relates to methods for preparing the particulate material and to its use.

WO 2021/084140 A2 discloses a particulate support material which can be used as an additive for the antimicrobial treatment of many different materials and which can be provided with elemental silver and elemental ruthenium. This material is characterized by a dark or black color with a correspondingly low brightness L*—for example, in the range of 35 to 45. The dark color can limit the usability for an antimicrobial treatment of light materials and objects.

U.S. Pat. No. 5,985,466 discloses a powder with metal oxide films on its surface in which the metal oxide films have an increased refractive index and which therefore has a high reflectivity and a luminous color. The powder comprises a base particle having, on its surface, a multilayer film comprising at least one metal oxide layer. The method for preparing the powder comprises dispersing a base particle in a solution of a metal alkoxide, hydrolyzing the metal alkoxide so as to obtain a metal oxide, and depositing a film of the metal oxide on the surface of the base particle, performing these steps two or more times in order to form a multilayer metal oxide film, and performing heat treatment in at least the last step. The multilayer metal oxide film is thereby regulated such that it has a suitable combination of constituent materials and suitable film thicknesses, in order to change the interference colors of the multilayer film and to give the powder a luminous color.

The brightness L* cited in the present description and in the claims is L* in the CIEL*a*b* color space (DIN EN ISO/CIE 11664-4:2020-03), determined spectrophotometrically in a measurement geometry of d/8°. The spectrophotometric measurement of powdered materials can be carried out on a material sample filled into a colorless glass vessel at a filling height of 1 cm through the flat glass bottom of the glass vessel placed on the measuring head of the spectrophotometer used.

The invention explained below solves the aforementioned color or brightness problem by providing a particulate material that can be used as an antimicrobial additive and has a comparatively light color—in particular, a lighter color than the material disclosed in WO 2021/084140 A2. Due to its light color, the particulate material according to the invention is also suitable for the antimicrobial design of materials and objects having a comparatively light color.

The invention relates to a particulate material Z composed of 15 to 50% by weight (wt %) of particles X consisting of water-insoluble support material T provided with elemental silver and elemental ruthenium, and 50 to 85 wt % of solid Y at least partially disposed on the particles X, wherein the solid Y is selected from the group consisting of aluminum oxide, aluminum hydroxide, aluminum oxyhydroxide, magnesium oxide, magnesium hydroxide, magnesium oxyhydroxide, calcium oxide, calcium hydroxide, calcium oxyhydroxide, silicon dioxide, silica, zinc oxide, zinc hydroxide, zinc oxyhydroxide, zirconium dioxide, zirconium(IV) oxyhydrates, titanium dioxide, titanium(IV) oxyhydrates, and combinations thereof. The wt % of the components X and Y adds up to 100 wt %. The choice of the X:Y weight ratio within the limits according to the invention allows for substantial and targeted influencing of the color or brightness L* of a particulate material Z according to the invention. A particulate material Z according to the invention has a color, e.g., a gray color, having a brightness L* in, for example, the range of 50 to 85. The proportion of silver plus ruthenium in a particulate material Z can, for example, be in the range of 0.015 to 25 wt %.

The solid Y makes up 50 to 85 wt % of the particulate material Z according to the invention and is at least partially disposed on the particles X of the particulate material Z according to the invention, i.e., a particular proportion of the 50 to 85 wt % of the solid Y can be present “loose” as free solid Y in addition to particles X having solid Y disposed thereon and optionally also particles X without solid Y disposed thereon. Accordingly, when viewed using scanning electron microscopy, the particulate material Z according to the invention comprises substantially or consists of a mixture of particles X with solid Y disposed thereon and free solid Y. The proportion of the free solid Y in the total amount of solid Y can, for example, be in the range of 10 to <100 wt %—for example, in the range of 10 to 90 wt %.

The solid Y is selected from the group consisting of aluminum oxide, aluminum hydroxide, aluminum oxyhydroxide, magnesium oxide, magnesium hydroxide, magnesium oxyhydroxide, calcium oxide, calcium hydroxide, calcium oxyhydroxide, silicon dioxide, silica, zinc oxide, zinc hydroxide, zinc oxyhydroxide, zirconium dioxide, zirconium(IV) oxyhydrates, titanium dioxide, titanium(IV) oxyhydrates, and combinations thereof. Titanium dioxide, titanium(IV) oxyhydrates, or combinations thereof, and in particular titanium dioxide, are preferred. The solid Y has a particle form, i.e., both free solid Y and solid Y disposed on particles X are formed as particles. In other words, solid Y is not layered; it does not form any layer or coating in the sense of a closed layer. Accordingly, but in other words, the particles X do not have a single- or multilayer coating—in particular, no single- or multilayer coating of which the layer or layers comprise solid Y or consist of solid Y.

Solid Y disposed on particles X adheres to the particles X and cannot be readily detached from the particles X—for example, by washing or shaking. The adhesion of the solid Y on the particles X is substantially physical in nature, but a possible formation of chemical bonds cannot be ruled out.

The particles X consist of particles, provided with elemental silver and elemental ruthenium, consisting of a support material T which is water-insoluble. The provision with elemental silver and elemental ruthenium means that the silver and the ruthenium can be present on inner surfaces (within pores and/or cavities) and/or on the outer surface of the support material particles, depending upon the type of support material T, and can thereby form, for example, a continuous or discontinuous layer and/or small silver or ruthenium particles. The silver and the ruthenium adhere to the surface of the support material particles; the adhesion is substantially physical in nature, but a possible formation of chemical bonds cannot be ruled out. The silver and the ruthenium are not alloyed, but, rather, are randomly distributed. It is clear to a person skilled in the art that the silver and the ruthenium on the surface thereof can also comprise other silver species as elemental metallic silver and other ruthenium species as elemental metallic ruthenium—for example, corresponding oxides and/or hydroxides and/or sulfides. The particles X consisting of the water-insoluble support material T provided with elemental silver and elemental ruthenium can, in particular, have a silver-plus-ruthenium weight proportion in the range of 0.1 to 50 wt % at a silver: ruthenium weight ratio in the range of 1 to 2,000 parts by weight of silver: 1 part by weight of ruthenium.

The fact that the water-insoluble support material T of the particles X is present in the solid state of aggregation is obvious to person skilled in the art.

The support material particles T can have a wide variety of particle shapes. For example, they can be irregularly shaped, or they can have a defined shape. They can, for example, be spherical, oval, platelet-shaped, or rod-shaped. The support material particles T can be porous and/or have cavities, or neither of the two. They can have a smooth or rough or structured outer surface. The support material particles can have an average particle size (d50) in, for example, the range of 0.4 to 100 μm. The absolute particle sizes of the support material particles T are generally less than 0.1 μm and generally do not exceed 1,000 μm.

The term “average particle size” used herein means the average particle diameter (d50) that can be determined by means of laser diffraction. Laser diffraction measurements can be carried out using a corresponding particle size measuring instrument—for example, a Mastersizer 3000 from Malvern Instruments.

The water-insoluble particulate support material T has a more or less high water absorption capacity between the particles and possibly also within the particles—for example, within pores and/or in depressions of the particle surface. The water-insoluble particulate support material T can be swellable with water or even capable of forming a hydrogel. It is not attacked, dissolved, or impaired in its property as a support material T by water. The water-insoluble actual support material T as such is preferably a non-water-repellent material. It is preferably hydrophilic, but, as stated, is in any case water-insoluble. The actual support material T can be a material selected from inorganic or organic substances or materials, in each case in particle form—for example, as a powder. In order to prevent any misunderstandings, the support material T is a silver-free and ruthenium-free substance or a silver-free and ruthenium-free material. The support material T is preferably neither magnetic nor magnetizable; it is not carbonyl iron. Examples of support materials of type T include glass; nitrides such as aluminum nitride, titanium nitride, silicon nitride; high-melting oxides such as aluminum oxide, titanium dioxide, silicon dioxide, e.g., as silica or quartz; silicates such as sodium aluminum silicate, zirconium silicate, zeolite; plastics materials such as (meth)acrylic homo- and copolymers and polyamides; modified or unmodified polymers of natural origin such as polysaccharides and derivatives, and in particular cellulose and cellulose derivatives; carbon substrates, and in particular porous carbon substrates; and wood. The water-insoluble support material T of the particles X can be the same as or different from the solid Y. Silicon dioxide, titanium dioxide, and cellulose are preferred support materials T, in the case of cellulose in particular in the form of linear cellulose fibers having a fiber length in, for example, the range of 10 to 1,000 μm.

The particles X consisting of the water-insoluble support material T provided with elemental silver and elemental ruthenium are freely flowable (non-clumping) powder. The free flowability of a freely flowable powder can be examined by means of the revolution powder analysis method mentioned below.

The particles X consisting of the water-insoluble support material T provided with elemental silver and elemental ruthenium can, for example, be a material of this kind or of the like as disclosed in WO 2021/084140 A2. WO 2021/084140 A2 also discloses methods for preparing particulate support material of type X provided with elemental silver and elemental ruthenium. In order to keep things brief, reference is made explicitly to the disclosure in WO 2021/084140 A2, page 2, line 6, to page 13, line 17, in this regard, both with respect to said material and said preparation method.

Particulate material Z according to the invention can be produced by bringing particles X consisting of water-insoluble support material T provided with elemental silver and elemental ruthenium into contact with at least one C1-C4 alkoxide of aluminum, magnesium, calcium, silicon, zinc, zirconium, and/or titanium in the presence of a quantity of water that is at least sufficient for complete hydrolysis of the at least one C1-C4 alkoxide. In this respect, the invention also relates to such a preparation method.

As stated, a particulate material Z according to the invention can be prepared by complete hydrolysis of at least one C1-C4 alkoxide of aluminum, magnesium, calcium, silicon, zinc, zirconium, and/or preferably titanium in the presence of particles X, i.e., the method for preparing particulate material Z according to the invention comprises the complete hydrolysis of at least one C1-C4 alkoxide of aluminum, magnesium, calcium, silicon, zinc, zirconium, and/or preferably titanium in the presence of particles X. In other words, the method for preparing particulate material Z according to the invention comprises particles X being brought into contact with at least one C1-C4 alkoxide of aluminum, magnesium, calcium, silicon, zinc, zirconium, and/or preferably titanium in the presence of an amount of water that is at least sufficient for the complete hydrolysis of said at least one C1-C4 alkoxide. C1-C4 alkoxides of aluminum, magnesium, calcium, silicon, zinc, zirconium, and/or preferably titanium are aluminum trialkoxides Al(OCₙH₂ₙ₊₁)₃, magnesium dialkoxides Mg(OCₙH₂ₙ₊₁)₂, calcium dialkoxides Ca(OCₙH₂ₙ₊₁)₂, silicon tetraalkoxides Si(OCₙH₂ₙ₊₁)₄, zinc dialkoxides Zn(OCₙH₂ₙ₊₁)₂, zirconium tetraalkoxides Zr(OCₙH₂ₙ₊₁)₄, and/or preferably titanium tetraalkoxides Ti(OCₙH₂ₙ₊₁)₄, in each case with n=1, 2, 3, or 4, and preferably 3. In the preferred case of n=3, it is particularly preferred to work with the isopropoxides, and in particular with titanium tetraisopropoxide Ti[OCH(CH₃)₂]₄—also referred to as TTIP. TTIP is preferably used alone. Since the hydrolysis proceeds quantitatively, it is simple for a person skilled in the art tasked with the preparation of a particulate material Z according to the invention to make a quantitative selection with regard to the at least one C1-C4 alkoxide of aluminum, magnesium, calcium, silicon, zinc, zirconium, and/or preferably titanium and particles X in accordance with stoichiometric considerations. With regard to said complete hydrolysis, said person skilled in the art would select at least one mole of water per mole of C1-C4 alkoxide of magnesium, calcium, or zinc to be hydrolyzed, at least 1.5 mole of water per mole of C1-C4 alkoxide of aluminum to be hydrolyzed, and at least two moles of water per mole of C1-C4 alkoxide of silicon, zirconium, or titanium. As will be explained below, the water can be provided as atmospheric moisture, as a moisture content of particles X, and/or in liquid form, and at least in an amount of water that is at least sufficient for complete hydrolysis of said at least one C1-C4 alkoxide, but generally in a superstoichiometric quantitative proportion relative to said hydrolysis reaction.

For the sake of brevity, the expression “C1-C4 alkoxide of aluminum, magnesium, calcium, silicon, zinc, zirconium, and/or preferably titanium” in the following is also referred to simply as “alkoxide.”

According to the invention, particles X can be brought into contact with at least one alkoxide in the presence of a quantity of water that is at least sufficient for its complete hydrolysis. The alkoxide or alkoxides are hydrolyzed to form the corresponding C1-C4 alcohols and corresponding solid Y selected from the group consisting of aluminum oxide, aluminum hydroxide, aluminum oxyhydroxide, magnesium oxide, magnesium hydroxide, magnesium oxyhydroxide, calcium oxide, calcium hydroxide, calcium oxyhydroxide, silicon dioxide, silica, zinc oxide, zinc hydroxide, zinc oxyhydroxide, zirconium dioxide, zirconium(IV) oxyhydrates, titanium dioxide, titanium(IV) oxyhydrates, and combinations thereof. The solid Y can thereby adhere proportionally to the particles X. As a result, particulate material Z according to the invention is formed as the process product. After the hydrolysis, the product obtained can be subjected to one or more further process steps if necessary. Examples of such process steps include, in particular, solid-liquid separation, washing, drying, and comminution.

The method according to the invention and, in particular, said hydrolysis can be carried out in a temperature range of, for example, 0 to 80° C., and preferably from 20 to 40° C.

In a first embodiment of the method according to the invention, the particles X can be brought into contact directly with the at least one alkoxide. In this first embodiment of the method according to the invention, the particles X can be dry or anhydrous or have a moisture content of, for example, in the range of >0 to 40 wt % of water—for example, in the form of residual moisture. The at least one alkoxide can be used undiluted or diluted with water-dilutable organic solvent—for example, as a solution in water-dilutable organic solvent. Such a preparation or solution can, for example, have a proportion by weight of the at least one alkoxide in the range of 20 to <100 wt %, and preferably 50 to 70 wt %. Examples of suitable water-dilutable organic solvents are in particular C1-C3 alcohols, and in particular ethanol. In the following, the “optionally diluted at least one alkoxide” is also referred to in the even shorter form “at least one alkoxide” for the sake of brevity.

In the first embodiment of the method according to the invention, water as such is not added at any point, and the hydrolysis can take place under the influence of atmospheric moisture and any moisture present in the particles X. The atmospheric moisture can naturally be prevailing atmospheric moisture, or it can be artificially set to a desired value, and the ingress of air can, if desired, be forced by deliberate air supply.

In the first embodiment of the method according to the invention, the particles X, which may have moisture, and the optionally diluted at least one alkoxide are brought into contact with one another so as to form a pulp-like, paste-like, or dough-like mass, a suspension, or preferably a freely flowable, impregnated particulate material. The optionally diluted at least one alkoxide here constitutes the impregnating agent. The particles X can be added to the at least one alkoxide or vice versa. The at least one alkoxide is preferably added to the previously supplied particles X. After the addition has ended, a period of time of, for example, in the range of 0.5 to 3 hours can expediently still be granted to the reaction mixture before further process steps are carried out. The completeness of the hydrolysis reaction and homogenization of the reaction mixture can thus be ensured. In general, mixing is carried out during and also after the addition. Examples of suitable mixing methods depend upon the nature of the mixed material and can accordingly comprise, for example, shaking, stirring, and/or kneading; in the preferred case of a mixed material in the form of freely flowable, impregnated particulate material, continuously or discontinuously operating powder mixing methods known to a person skilled in the art are suitable, e.g., mixing in a drum mixer, in a tumble mixer, in a pressure filter operated without pressure and having a stirring apparatus, or in a vacuum mixing dryer operated in a vacuum-free state and without heating. The expression “freely flowable impregnated particulate material” used here describes a material in the form of impregnated grains or flakes which may each comprise one or more particles X. The freely flowable, impregnated particulate material is not liquid, a liquid dispersion or a suspension; rather, it is a freely flowable material in the form of freely flowable powder. Its free flowability or, generally, the free flowability of a freely flowable powder can be examined by means of revolution powder analysis. For this purpose, a cylindrical measuring drum can be filled with a defined volume of the freely flowable, impregnated particulate material. The measuring drum has a defined diameter and a defined depth. The measuring drum rotates about the horizontally oriented cylinder axis at a defined constant speed. One of the two end faces of the cylinder, which together enclose the freely flowable particulate material filled into the cylindrical measuring drum, is transparent. Before the measurement is started, the measuring drum is rotated for 60 seconds. For the actual measurement, images of the freely flowable particulate material are subsequently taken during the rotation along the axis of rotation of the measuring drum using a camera having a high frame rate of, for example, 5 to 15 images per second. The camera parameters can be selected such that the highest possible contrast at the material-air interface is achieved. During the rotation of the measuring drum, the freely flowable particulate material is entrained against gravity up to a particular height before it flows back into the lower part of the drum. The return flow takes place in a slide-like manner (discontinuously) and is also referred to as an avalanche. A measurement is terminated when the sliding of a statistically relevant number of avalanches, e.g., 200 to 400 avalanches, has been recorded. Subsequently, the camera images of the freely flowable particulate material are evaluated by means of digital image analysis. During the revolution powder analysis, the so-called avalanche angle as well as the period of time between two avalanches (“avalanche time”) can be determined as parameters characteristic of the free flowability. The avalanche angle is the angle of the material surface at which the avalanche breaks out, and thus represents a measure of the height of the pile-up of the free-flowing particulate material before this pile-up collapses in an avalanche-like manner. The period of time between two avalanches corresponds to the time that passes between the occurrence of two avalanches. A suitable tool for carrying out said revolution powder analysis and for determining the avalanche angle and period of time between two avalanches is the Revolution Powder Analyzer from PS Prozesstechnik GmbH, Neuhausenstrasse 36, CH-4057 Basel. It is recommended that the operating instructions and recommendations enclosed with the device be followed. The measurement is usually carried out at room temperature or 20° C. In the present case, the freely flowable, impregnated particulate material can have an avalanche angle in, for example, the range of 40 to 90 degrees and that is determined based upon a 100 mL test quantity of the material using said device at 0.5 revolutions per minute and using a cylinder having an inner depth of 35 mm and an internal diameter of 100 mm; the period of time between two avalanches can be in the range of 2 to 5 seconds, for example, and may constitute a characterizing feature of the free flowability of the freely flowable, impregnated particulate material.

In the first embodiment of the method according to the invention, the particles X can be brought into contact with the at least one alkoxide in multiple stages performed in the same way, i.e., the at least one alkoxide can be brought into contact with the total amount of the particles X in multiple portions, wherein a drying process is carried out in each case between the individual stages.

A second embodiment of the method according to the invention differs from the first embodiment in that the particles constituting a freely flowable powder, regardless of whether they are anhydrous or have a moisture content, are initially uniformly moistened with water or additionally moistened with water so as to obtain particles X′. The particles X′ therefore differ from the particles X on account of a water content or a higher water content. The further procedure in the second embodiment of the method according to the invention corresponds to the procedure as in the first embodiment of the method according to the invention. During the moistening, a desired water content of the particles X′ can be set—for example, in the range of 1 to 50 wt %. The particles X can thereby be added to the water or vice versa—in each case so as to form a mixture. In general, mixing is carried out during and also after the addition. Examples of suitable mixing processes are based upon the nature of the mixed material and can accordingly comprise, for example, shaking, stirring, and/or kneading; in the preferred case of a mixed material in the form of freely flowable particulate material moistened with water, continuously or discontinuously operating powder mixing methods known to the person skilled in the art are suitable—for example, the aforementioned in the first embodiment of the method according to the invention. Preferably, the water is added to the previously supplied particles X optionally containing moisture. After the addition has ended, a period of time of, for example, in the range of up to 1 hour can expediently still be granted to the moist mixed material before it is brought into contact with the at least one alkoxide. Homogenization of the mixed material or uniform moistening can thus be ensured; in other words, a uniform distribution of the water within the resulting particles X′ can thus be ensured before they are subsequently brought into contact with the at least one alkoxide. In general, mixing is carried out during and also after the addition.

A free flowability of particles X′ can be examined by means of the above-mentioned revolution powder analysis; the particles X′ can have an avalanche angle in, for example, the range of 40 to 90 degrees that is determined based upon a 100 mL test quantity using the Revolution Powder Analyzer at 0.5 revolutions per minute and using a cylinder having an inner depth of 35 mm and an internal diameter of 100 mm; the period of time between two avalanches can, for example, be in the range of 2 to 5 seconds.

In the second embodiment of the method according to the invention, the particles X′ and the at least one, optionally diluted, alkoxide are brought into contact with one another so as to form a pulp-like, paste-like, or dough-like mass, a suspension, or preferably a freely flowable, impregnated particulate material. The at least one alkoxide constitutes the impregnating agent. The particles X′ can be added to the at least one alkoxide or vice versa. The at least one alkoxide is preferably added to the previously supplied particles X. After the addition has ended, a period of time in, for example, the range of 0.5 to 3 hours can expediently still be granted to the reaction mixture before further process steps are carried out. The completeness of the hydrolysis reaction and homogenization of the reaction mixture can thus be ensured. In general, mixing is carried out during and also after the addition. Examples of suitable mixing processes are based upon the nature of the mixed material and can accordingly comprise, for example, shaking, stirring, and/or kneading; in the preferred case of a mixed material in the form of freely flowable particulate material, continuously or discontinuously operating powder mixing methods known to the person skilled in the art are suitable—for example, the procedures already mentioned with respect to the first embodiment of the method according to the invention.

In a third embodiment of the method according to the invention, the particles X which optionally contain moisture are initially suspended in an aqueous medium of water and a water-dilutable organic solvent. The suspension can consist, for example, of 50 to 95 wt % aqueous medium and 5 to 50 wt % particles X, the weight percentages adding up to 100 wt %. The aqueous medium can, for example, consist of >0 to 95 wt % water and 5 to <100 wt % water-dilutable organic solvent, the weight percentages adding up to 100 wt %. Examples of suitable water-dilutable organic solvents are in particular C1-C3 alcohols, and in particular ethanol.

The suspension and the at least one optionally diluted alkoxide are then brought into contact with one another. The suspension can be added to at least one optionally diluted alkoxide or vice versa. The at least one, optionally diluted, alkoxide is preferably added to the previously supplied suspension. The addition can take place continuously or discontinuously. After the addition has ended, a period of time in, for example, the range of 0.5 to 3 hours can expediently still be granted to the reaction mixture before further process steps are carried out. The completeness of the hydrolysis reaction and homogenization of the reaction mixture can thus be ensured. In general, mixing is carried out during and also after the addition—for example, by means of shaking and/or stirring.

The first and third embodiments of the method according to the invention are preferred embodiments.

As already stated, after the hydrolysis, the process product obtained can be subjected to one or more further process steps as required. Examples of such process steps include, in particular, solid-liquid separation, washing, drying, and comminution. Such further process steps take place in the case of the second and third embodiment, but generally also in the case of the first embodiment. Thus, in the first embodiment of the method according to the invention, it is generally expedient if successive drying and comminution takes place. In the second and third embodiment, washing and solid-liquid separation are expediently carried out alternately, and then drying and comminution one after the other.

Solid-liquid separation can be carried out using methods known to a person skilled in the art, e.g., decanting, pressing out, filtering, filtration with suction, centrifuging, or similarly operating methods, and allows for liquid (hydrolytically formed C1-C4 alcohols, water, water-dilutable solvent) to at least largely be separated from particulate material Z formed or washed in the course of the hydrolysis. As a result, a moist particulate material Z that still contains liquid is obtained.

Washing is carried out expediently with water. In the process, water-soluble constituents can be removed—for example, C1-C4 alcohols formed during hydrolysis and/or water-dilutable organic solvent.

Drying can either take place under ambient conditions in the air without special measures or can be assisted by means of reduced pressure and/or supply of heat. Suitable drying temperatures are, for example, in the range of 50 to 150° C. After drying, no further heat treatment is necessary, such as tempering at a higher temperature than the drying temperature. Such a heat treatment generally and preferably does not take place.

Comminution can take place, for example, by means of mortars or grinding—for example, using a rotor beater mill.

The method according to the invention is scalable in a production scale; the particulate material Z according to the invention can be produced efficiently and in batch sizes in the amount of, for example, up to 5 tons.

The particulate material Z according to the invention has antimicrobial activity comparable to the material known from WO 2021/084140 A2 as an antimicrobial additive. The invention therefore also relates to the use of the particulate material Z according to the invention as an additive for the antimicrobial treatment of metal surfaces; coating agents; plasters; molding bases; plastics materials in the form of plastics films, plastics parts, or plastics fibers; synthetic resin products; ion-exchange resins; silicone products; cellulose-based products; foams; textiles; cosmetics; hygiene articles, and many others. The cellulose-based products can thereby be selected, for example, from the group consisting of paper products, cardboards, wood fiber products, and cellulose acetate, and the plastics materials can be selected, for example, from the group consisting of ABS plastics material, PVC (polyvinyl chloride), polylactic acid, PU (polyurethane), poly(meth)acrylate, PC (polycarbonate), polysiloxane, phenol formaldehyde resin, melamine formaldehyde resin, polyester, polyamide, polyether, polyolefin, polystyrene, hybrid polymers thereof, and mixtures thereof. In principle, the color of the materials or objects to be rendered antimicrobial is arbitrary in this case. In particular, however, the materials or objects to be rendered antimicrobial can be those having a light color—for example, those having a chromatic or achromatic color having a brightness L′ in the range of 50 to 90. It is thereby possible to select particulate material Z according to the invention with a color or brightness that is adapted to a material to be rendered antimicrobial or to an object to be rendered antimicrobial. It is also possible to use a particulate material Z according to the invention in combination with a colorless or darker antimicrobially active additive; for example, it is possible to use particulate material Z according to the invention in combination with an antimicrobially active particulate support material provided with elemental silver and elemental ruthenium (for example, that known from WO 2021/084140 A2).

### Examples

### Reference Example 1 (Preparation of a Cellulose Powder Provided with Elemental Silver and Elemental Ruthenium; in Accordance with Embodiment 3 from WO 2021/084140 A2)

75.6 g (445 mmol) of solid silver nitrate and 13.94 g of ruthenium nitrosyl nitrate solution (ruthenium content 19.0 wt %; 26.2 mmol Ru) were dissolved in 416.8 g of deionized water, and the aqueous precursor solution obtained in this way was mixed homogeneously with 211.2 g of cellulose powder (Vitacel® L-600 from Rettenmaier und Söhne GmbH & Co KG) to form an orange, freely flowable particulate material. At room temperature, 705 mL of an aqueous hydrazine solution having a pH of 13.9 [4.19 g (131 mmol) of hydrazine and 81.81 g of a 32 wt % sodium hydroxide solution (654.51 mmol NaOH), rest: water] were metered in at room temperature at a metering rate of 30 mL/min while stirring. Over time, a homogeneous pulp that became easier to stir was formed. After the metering had ended, stirring was continued for 30 minutes until nitrogen release could no longer be observed. The material was then filtered off by means of suction, washed with a total of 1,000 mL of water, and dried in a drying cabinet at 105° C./300 mbar to a residual moisture content of 15 wt %. A silver content of 18.9 wt % and a ruthenium content of 1.0 wt % of the final product (relative to 0 wt % residual moisture) was determined by means of ICP-OES.

The end product was comminuted with an agate mortar; the powder thus obtained appeared black to the human eye. After filling into a colorless snap-cap vial to a filling height of 1 cm, an L* value of 44 was determined using a spectrophotometer (ColorLite sph900 spectrometer) with a measurement geometry of d/8° through the glass bottom of the snap-cap vial placed on the measuring head of the spectrophotometer.

### Invention Example 2 (Preparation of a Z-Type Particulate Material)

50 g of the black powder from reference example 1 containing 15 wt % residual moisture were initially supplied so as to be in contact with the ambient atmosphere into a 6 L flask and suspended in a mixture of 970 mL of ethanol and 35 mL of deionized water. 533.85 g of TTIP were dissolved in 400 mL of ethanol and added to the stirred suspension at a rate of 5 mL/min, and then stirred for a further 2 hours. The mixture obtained was then filtered, and the resulting light-gray solid was washed with 7 L of deionized water, dried at 105° C. for 24 h (300 mbar), and then comminuted using an agate mortar. A silver content of 4.3 wt % and a ruthenium content of 0.2 wt % of the end product (relative to 0 wt % residual moisture) was determined by means of ICP-OES. The powder thus obtained appeared light gray to the human eye. After filling into a colorless snap-cap vial to a filling height of 1 cm, an L* value of 65 was determined using a spectrophotometer (ColorLite sph900 spectrometer) with a measurement geometry of d/8° through the glass bottom of the snap-cap vial placed on the measuring head of the spectrophotometer.

### Invention Example 3 (Preparation of a Z-Type Particulate Material)

50 g of the black powder from reference example 1 containing 15 wt % residual moisture was dried at 105° C./300 mbar. The dry powder obtained was initially supplied so as to be in contact with the ambient atmosphere into a 6 L flask and further processed in the same way as in example 2. A silver content of 4.3 wt % and a ruthenium content of 0.2 wt % of the end product (relative to 0 wt % residual moisture) was determined by means of ICP-OES. The powder thus obtained appeared light gray to the human eye. After filling into a colorless snap-cap vial to a filling height of 1 cm, an L* value of 65 was determined using a spectrophotometer (ColorLite sph900 spectrometer) with a measurement geometry of d/8° through the glass bottom of the snap-cap vial placed on the measuring head of the spectrophotometer.

### Invention Example 4 (Preparation of a Z-Type Particulate Material

10 g of the black powder from reference example 1 containing 15 wt % residual moisture was mixed dropwise with 6.84 g of TTIP while stirring. The mixture was stirred for 10 min with admission of air before it was transferred into a ceramic bowl and dried at 105° C./300 mbar. The obtained powder was comminuted using an agate mortar. This step sequence was repeated nine times, i.e., 68.4 g of TTIP were added overall. A silver content of 6.5 wt % and a ruthenium content of 0.3 wt % of the end product (relative to 0 wt % residual moisture) was determined by means of ICP-OES. The powder thus obtained appeared light gray to the human eye. After filling into a colorless snap-cap vial to a filling height of 1 cm, an L* value of 56 was determined using a spectrophotometer (ColorLite sph900 spectrometer) with a measurement geometry of d/8° through the glass bottom of the snap-cap vial placed on the measuring head of the spectrophotometer.

### Invention Example 5 (Preparation of a Z-Type Particulate Material)

10 g of the black powder from reference example 1 containing 15 wt % of residual moisture were dried at 105° C./300 mbar. The dry powder obtained was processed further in the same way as in example 4. A silver content of 6.5 wt % and a ruthenium content of 0.3 wt % of the end product (relative to 0 wt % residual moisture) was determined by means of ICP-OES. The powder thus obtained appeared light gray to the human eye. After filling into a colorless snap-cap vial to a filling height of 1 cm, an L* value of 56 was determined using a spectrophotometer (ColorLite sph900 spectrometer) with a measurement geometry of d/8° through the glass bottom of the snap-cap vial placed on the measuring head of the spectrophotometer.

1. A particulate material Z composed of 15 to 50 wt % of particles X consisting of water-insoluble support material T provided with elemental silver and elemental ruthenium and 50 to 85 wt % of solid Y at least partially disposed on the particles X, wherein the solid Y is selected from the group consisting of aluminum oxide, aluminum hydroxide, aluminum oxyhydroxide, magnesium oxide, magnesium hydroxide, magnesium oxyhydroxide, calcium oxide, calcium hydroxide, calcium oxyhydroxide, silicon dioxide, silica, zinc oxide, zinc hydroxide, zinc oxyhydroxide, zirconium dioxide, zirconium(IV) oxyhydrates, titanium dioxide, titanium(IV) oxyhydrates, and combinations thereof.

2. The particulate material Z according to claim 1, having a color having a brightness L* in the range of 50 to 85.

3. The particulate material Z according to claim 1, wherein the solid Y is formed as particles.

4. The particulate material Z according to claim 1, wherein the particles X have a silver-plus-ruthenium weight proportion in the range of 0.1 to 50 wt % at a silver: ruthenium weight ratio in the range of 1 to 2,000 parts by weight of silver: 1 part by weight of ruthenium.

5. The particulate material Z according to claim 1, wherein the support material T is swellable with water or is capable of forming a hydrogel.

6. The particulate material Z according to claim 1, wherein the support material T is selected from the group consisting of glass, nitrides, high-melting oxides, silicates, plastics materials, modified or unmodified polymers of natural origin, carbon substrates, and wood.

7. The particulate material Z according to claim 1, wherein the support material T is silicon dioxide, titanium dioxide, or cellulose.

8. The particulate material Z according to claim 1, wherein the support material T is the same as or different from the solid Y.

9. A method for preparing particulate material Z according to claim 1, wherein particles X consisting of water-insoluble support material T provided with elemental silver and elemental ruthenium are brought into contact with at least one C1-C4 alkoxide of aluminum, magnesium, calcium, silicon, zinc, zirconium, and/or titanium in the presence of a quantity of water that is at least sufficient for complete hydrolysis of the at least one C1-C4 alkoxide.

10. The method according to claim 9, wherein the at least one C1-C4 alkoxide is a titanium tetraalkoxide.

11. The method according to claim 9, wherein the water is provided as atmospheric moisture, as a moisture content of particles X, and/or in liquid form.

12. The method according to claim 9, wherein the product obtained following the complete hydrolysis is subjected to one or more further process steps selected from the group consisting of solid-liquid separation, washing, drying, and comminution.

13. The method according to claim 9, wherein the particles X are brought into contact directly with the at least one alkoxide or are initially uniformly moistened with water or are initially suspended in an aqueous medium of water and a water-dilutable organic solvent.

14. A use of a particulate material Z according to claim 1, or prepared according to a method of preparing particulate material Z, wherein particles X consisting of water-insoluble support material T provided with elemental silver and elemental ruthenium are brought into contact with at least one C1-C4 alkoxide of aluminum, magnesium, calcium, silicon, zinc, zirconium, and/or titanium in the presence of a quantity of water that is at least sufficient for complete hydrolysis of the at least one C1-C4 alkoxide, as an additive for the antimicrobial treatment of materials or objects to be rendered antimicrobial.

15. The use according to claim 14, wherein the materials or objects to be rendered antimicrobial have a chromatic or achromatic color having a brightness L* in the range of 50 to 90.
